(19) United States
(12) Patent Application Publication
(10) Pub. No.: US 2017/0178530 A1
(43) Pub. Date: Jun. 22, 2017

(54) METHODS AND SYSTEMS FOR GENERATING NEW VOCABULARY SPECIFIC ASSIGNMENTS USING A CONTINUOUSLY UPDATED REMOTE VOCABULARY DATABASE

(71) Applicants: Christopher Twyman, Milton, MA (US); Ian Garland, Matlock (GB); Ken C. Haynes, Needham, MA (US)

(72) Inventors: Christopher Twyman, Milton, MA (US); Ian Garland, Matlock (GB); Ken C. Haynes, Needham, MA (US)

(73) Assignee: Boomwriter Media, Inc., Milton, MA (US)

(21) Appl. No.: 15/221,381

(22) Filed: Jul. 27, 2016

Related U.S. Application Data
(60) Provisional application No. 62/197,185, filed on Jul. 27, 2015.

(51) Int. Cl. G09B 7/02; G09B 19/00

(52) U.S. Cl. CPC G09B 7/02; G09B 19/00

(57) ABSTRACT

A method and system for generating a new vocabulary based writing assignment, performed by at least one computer processor executing computer program instructions stored on at least one non-transitory computer-readable medium, the method including: receiving additional input from the user regarding a desired subject; receiving input from the user regarding one or more students to be associated with the new writing project, wherein the one or more students are selected from a student database; generating a potential vocabulary word list; selecting one or more individual vocabulary words from the potential vocabulary word list; forming a word bank being associated with the new writing project using the selected individual vocabulary words; receiving assignment instructions from the administrator, the assignment instructions correlating to the new writing project; and generating a complete writing project including the word bank, and the assignment instructions.

### PRIORITY

This application claims the benefit U.S. patent application No. 62/197,185 filed on Jul. 27, 2015 which is hereby incorporated by reference in its entirety.

### BACKGROUND

The disclosure relates to education, namely the incorporation of a given curriculum into new assignments. More particularly, the methods and systems described herein relate to computer systems configured to aid educators in vocabulary tracking, vocabulary suggestion and generation, creating assignments, and monitoring student progress. However, these methods and systems described below are not exclusive to education.

In conventional systems, standardized curriculums are used which incorporate a standard word assignment list for various subjects. The educators are required to incorporate, at a minimum, the words from the curriculum throughout the year. Educators often use additional supplemental words in conjunction with the required curriculum to provide better context, or better preparation for future subjects. The words can be utilized in writing assignments, spelling lists, etc. Often the assignments and words are physically written out and copied by the individual students.

It has been recognized that electronic creation and distribution of the assignments can help educators be more consistent and improve the supplemental vocabulary used in providing the best education to associated students.

Disclosed herein are various methods and systems which improve the quality of the assignments, aid educators in reviewing and assisting students through the assignments, and provides students with help and tracking through the completion of the assignments.

### BRIEF SUMMARY

Disclosed herein is a method and system for generating a new vocabulary based writing assignment. The method can be performed by at least one computer processor executing computer program instructions stored on at least one non-transitory computer-readable medium wherein the method can include receiving, by means of a server, from a user portal, a request to generate a new writing assignment from a user. The user can provide, and the system can receive, additional input regarding a desired subject. Additionally, additional input can be received from the user regarding one or more students to be included in the new writing assignment. The one or more students can be selected from a student database being stored on a non-transitory computer-readable medium and the student can have an associated grade level from a range or acceptable grade levels, or age levels, etc.

Then, using processing circuitry and based on the various inputs and specified students, a primary list of suggested vocabulary words can be generated from a vocabulary database being stored on the non-transitory computer-readable medium, wherein each of the vocabulary words in the primary list of suggested vocabulary words are correlated to attributes of the one or more students and the desired subject;

The user can then select one or more of the vocabulary words from the primary list of suggested vocabulary words so as to form an assignment vocabulary list using the selected vocabulary words.

The user can then be prompted to input additional assignment instructions, the assignment instructions correlating to the assignment vocabulary list. Then the system can create, log, and distribute a new assignment using processing circuitry wherein the new assignment incorporates the assignment vocabulary list and the assignment instructions and distributes the new assignment to each of the one or more students selected from the student database.

In some embodiments a secondary list of suggested vocabulary terms can be generated, the secondary list of suggested vocabulary terms being based on an associated grade level of the one or more students, the desired subject, and preexisting usage information from additional user's having similar assignment attributes.

In other embodiments the vocabulary database can include a plurality of vocabulary words, each of the vocabulary words including usage markers. In some of these embodiments each of the usage markers can include information regarding the grade level of each of the one or more students, the number of times the particular vocabulary word has been assigned, and the associated desired subject of the new assignment. In this secondary list of suggested vocabulary terms, the secondary list of suggested vocabulary terms can be based on the usage markers.

In yet other embodiments the primary list of suggested vocabulary words can include a plurality of vocabulary words from a preexisting standard curriculum database. Additionally in such embodiments used in conjunction with multiple vocabulary lists, each of the vocabulary words within the secondary lists of suggested vocabulary terms can be ranked according to frequency of use.

In some embodiments utilizing usage markers, the usage markers can include information regarding relationships between words which are frequently selected together.

The method can further include tracking student behaviors wherein the new assignment is transmitted to, and receipt verified by, each of the one or more students. Then each student can provide input relating to the new assignment. Such input can be analyzed during the input stage using processing circuitry, wherein a match between portions of the input and each of the vocabulary words on the assignment vocabulary list can be determined and recognized so as to track progress.

In some embodiments the assignment vocabulary list can be displayed to each student while receiving the student input and a status indicator can be provided to each student regarding each vocabulary word from the assignment vocabulary list as the vocabulary word is used.

As students work or complete the new assignment, progress can be tracked and transmitted to and from the network and either progressively transmitted or transmitted upon saving, etc. In cases of progressive transmission, a means for continuously monitoring each student's input can be provided to the user so as to provide the ability to provide additional instructions or suggestions to each of the students as the assignment is in progress.

In yet other embodiments a method of creating a database of subject and grade level appropriate vocabulary words is contemplated which involves some or more of the following steps: extracting from one or more writing assignments, words used, subject type of the writing assignment, and the grade level associated with each student generating the words used in generating the completed written assignment; extracting from a plurality of writing assignments at least some regional defining information including school, district, city, county, state or country; tallying counts associated with each vocabulary word associated with each subject and each grade level; and selecting from the list of highest count vocabulary words and comparing said list with a known standard of vocabulary words.

In yet other embodiments a method of generating a vocabulary database is contemplated which includes the steps of: receiving an assignment vocabulary list, the assignment vocabulary list including a plurality of individual vocabulary words; receiving information regarding a class list including information regarding grade levels of a plurality of students associated with the class list; receiving subject information associated with the assignment vocabulary list; associating one or more markers to each individual vocabulary word, the marker containing information regarding at least the subject information associated with the assignment vocabulary list and the grade levels of each of the plurality of students; importing the assignment vocabulary list into a word database stored on a remotely accessible non-transitory computer-readable medium; accessing the word database from a user portal; receiving information pertaining to a desired grade level; receiving information pertaining to a desired subject; and determining a suggested vocabulary list, the suggested vocabulary list being determined by process circuitry wherein each individual vocabulary word is ranked based on a word use frequency for each individual vocabulary word, wherein the use frequency is associated with at least the grade level and subject information.

In another exemplary embodiment, a platform for conducting content generating activities tied to specific vocabulary is contemplated. For example, a user can select from a list a type of project. Such projects can include a new chapter, a poem, a technical paper, a commercial, an instruction pamphlet, and so forth. Next the user can select a category to be associated with the type of project. Categories can include, but are not limited to: health, consumer products, fantasy, science-fiction, history, adventure, drama, engineering, biology and so forth. Each category can have one or more sub-categories, for example, health could have the subcategories of women's health, with another sub-category of dermatology. Once the project type, category and sub-categories are selected, the platform can generate a list of vocabulary words based on those criteria from a database of vocabulary words. Once the user generates the new content in the platform, the system can analyze the new content to determine ranking priority and usage of the vocabulary words as well as determine the usage of other vocabulary words used and update or build links for those other vocabulary words in the vocabulary database.

In some instances, another selection regarding the mode can be selected. Some modes can include, commonly used, rarely used, trending, gamification, level and so forth. The mode can further determine the number and type of vocabulary words given for a particular content generating activity. For example, commonly used can help pull the most commonly used vocabulary words for a given type and category. Rarely used, can produce a list of vocabulary words that are used less frequently. Trending can produce a list of words that have had an increase in usage either by number or percentage. Gamification mode can include rewards, recognition, time-taken for using the given list of vocabulary words. Level mode can include the difficulty of a given vocabulary word, where difficulty can be comprised of spelling, pronunciation, rarity, and other factors. In essence, the mode can further determine the priority placed on the resulting vocabulary list that is generated to be used in the content generating project.

### BRIEF DESCRIPTION OF THE DRAWINGS

FIG. 1 illustrates a first system capable of carrying out the associated methods discussed herein utilizing a remote server;

FIG. 2 illustrates a second exemplary system capable of carrying out the associated methods discussed herein utilizing a local area network and local based server;

FIG. 3 illustrates a screenshot of an online portal and illustrative flowchart illustrating either user or administrator login options;

FIG. 4 illustrates a screenshot of an administrator login portal and project creation options;

FIG. 5 illustrates a screenshot within an administrator portal with a project creation pane;

FIG. 6 illustrates a screenshot similar to that of FIG. 5 wherein a drop-down option menu is selected within the project creation pane;

FIG. 7 illustrates a saved project list within the administrator portal after creation of at least one project;

FIG. 8 illustrates a project setup prompt menu within the administrator portal upon selection of a created project;

FIG. 9 illustrates a word bank or vocabulary selection menu associated with a particular created project illustrating various methods for creating a vocabulary list associated with a particular created project;

FIG. 10 illustrates a trending vocabulary list option for inclusion in the word bank of FIG. 9;

FIG. 11 illustrates a user filter drop-down menu for facilitating assignment of appropriate words to a particular user group;

FIG. 12 illustrates a user selection drop-down menu for facilitating assignment of appropriate words to individual users or a particular group of users;

FIG. 13 illustrates various potential instruction fields or various project requirement options that can be filled by an administrator within the administrator portal prior to assignment of a created project to one or more users;

FIG. 14 illustrates a various potential instruction project overview or review pane which allows for review by an administrator within the administrator portal prior to assignment of a created project to one or more users;

FIG. 15 illustrates a due date or criteria prompt which allows for deadline setting by an administrator within the administrator portal just prior to transmission of the assignment of a created project to one or more users;

FIG. 16 illustrates a status portal which allows for an administrator within the administrator portal to view progress of individual users by the administrator after assignment of a created project to one or more users as said users create entries or responses to the assigned project;

FIG. 17 illustrates a user or administrator view upon selection of a particular assigned project;

FIG. 18 illustrates a screenshot of a user portal; and

FIG. 19 illustrates a screenshot of a user view within an assigned project.

### DETAILED DESCRIPTION

The present invention relates to systems and methods for generating, distributing, and collecting assignments to and from a group of users, i.e. students. The system can include various user portals, including separate portals for teachers or administrators and students or normal users for accessing the assignment system. In particular these assignments include a customized vocabulary list associated with a particular assignment, wherein the custom vocabulary list is generated using a plurality of methods. The use of the individual vocabulary words can be monitored by an application within each assignment for each particular student or user, the use being viewable and assessed by the administrator or teacher. It will be appreciated that differing portals can be created and used between students and teachers, wherein the administrator portals allow for varying functions available for network administrators, teachers, programmers, etc.

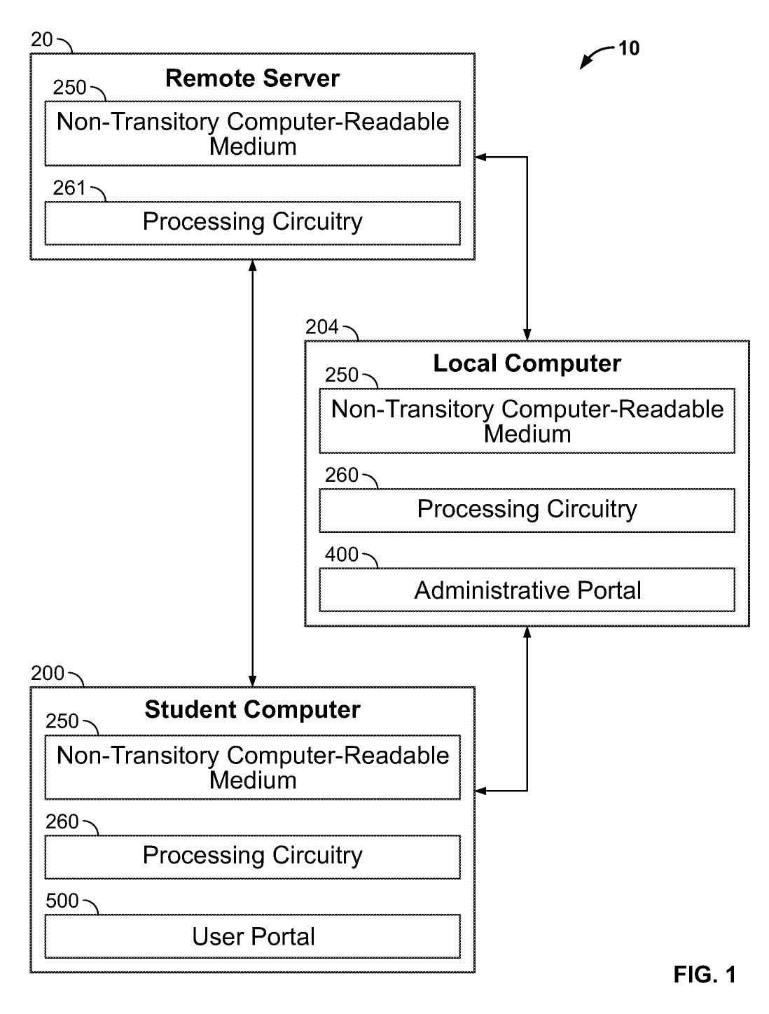

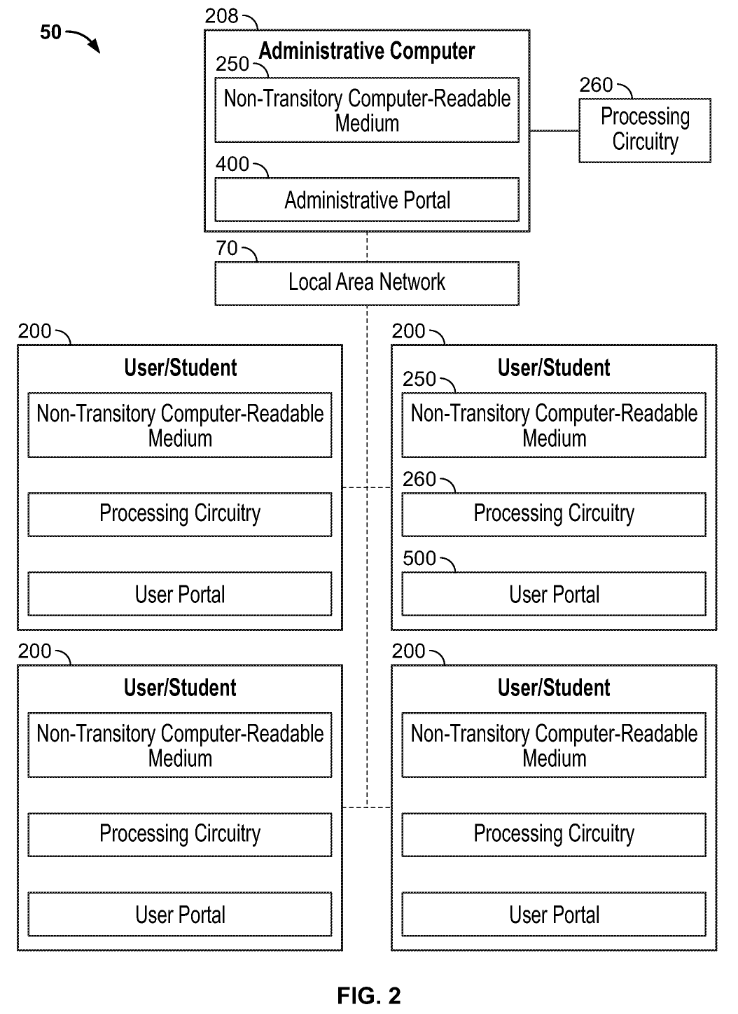

As illustrated in FIGS. 1-2, a remote based system 10 can be utilized to perform the various methods disclosed herein. Alternatively a locally based system 50 can be utilized to perform the various methods disclosed herein.

As illustrated in FIG. 1 a remotely based system 10 can be provided wherein a server 20 can be provided which includes one or more non-transitory computer-readable mediums 250, along with processing circuitry 261 configured to perform functions or applications containing computer instructions for performing the various methods discussed herein. A local computer 204, i.e. an administrator or teacher computer can also include non-transitory computer-readable mediums 250 as well as processing circuitry 260 for performing computer implemented instructions as allowed through an administrator portal 400, which will be discussed in more detail below. The system 10 can further include one or more student computers 200, also having non-transitory computer-readable media 250, and processing circuitry 260, the processing circuitry being configured to allow access by users or students to a user portal 500, which will also be discussed in more detail below.

As illustrated in FIG. 2 a locally based system 50 can be provided wherein a local administrative computer 204 is provided with hosting capabilities and instructions for storing necessary databases and computer instructions so as to provide the requisite functionality. The student or user computers 200 can then be operatively connected to the administrative computer 204. Each computer also including one or more non-transitory computer-readable mediums 250, along with processing circuitry 260 configured to perform functions or applications containing computer instructions for performing the various methods discussed herein. A local computer 204, i.e. an administrator or teacher computer can also include non-transitory computer-readable mediums 250 as well as processing circuitry 260 for performing computer implemented instructions as allowed through an administrator portal 400, which will be discussed in more detail below. The system 10 can further include one or more student computers 200, also having non-transitory computer-readable media 250, processing circuitry 260, the processing circuitry being configured to allow access by users or students to a user portal 500, which will also be discussed in more detail below.

Further, any appropriate network communication can be provided between the various hardware or software so as to provide any necessary communication therebetween, i.e. Local Area Networks 70, internet, etc.

It will also be appreciated that the non-transitory computer readable medium 250 can include various stored information including student databases corresponding to various classrooms, student groups, etc. Additionally the non-transitory computer-readable media 250 can also store vocabulary word databases and usage information associated with each of the words contained therein.

The system as described can aid a teacher, i.e. an administrative user, in the creation of a new assignment 420 for distribution to a designated group of students 470. The administrative user can open an administrative portal 400 on a local computer 204 whereupon a set of computer instructions stored either locally or remotely can prompt the user to input various parameters relating to the desired assignment, as well as to whom the assignment will be issued. Upon creation of the new assignment 420, the assignment can be distributed to the student users 470 who can access the assignment through a user portal 500, wherein they can view the assignment, instructions and parameters, and input or otherwise submit a response. The teacher or administrator can track submissions and progress of the students during the assignment period through the administrative portal 400.

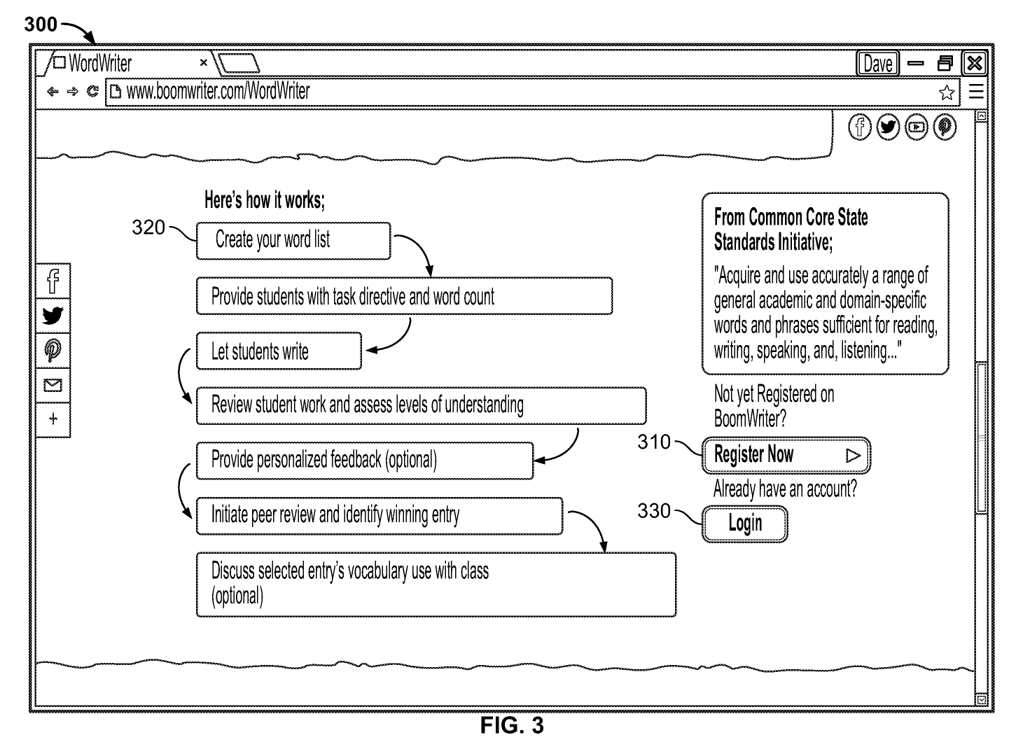

FIG. 3 illustrates an exemplary login portal 300. The login portal 300 can include a brief explanation 320 regarding the system and the functionalities provided thereby. The login portal 300 can also include a registration link 310 or a login link 330. It will be appreciated that a potential user can create a profile as a student or non-administrative user, or as a teacher or administrative user. In some instances certain users can have both administrative and non-administrative rights depending on the particular assignments accessed therein. In some instances, the administrator creates the profile for a given user.

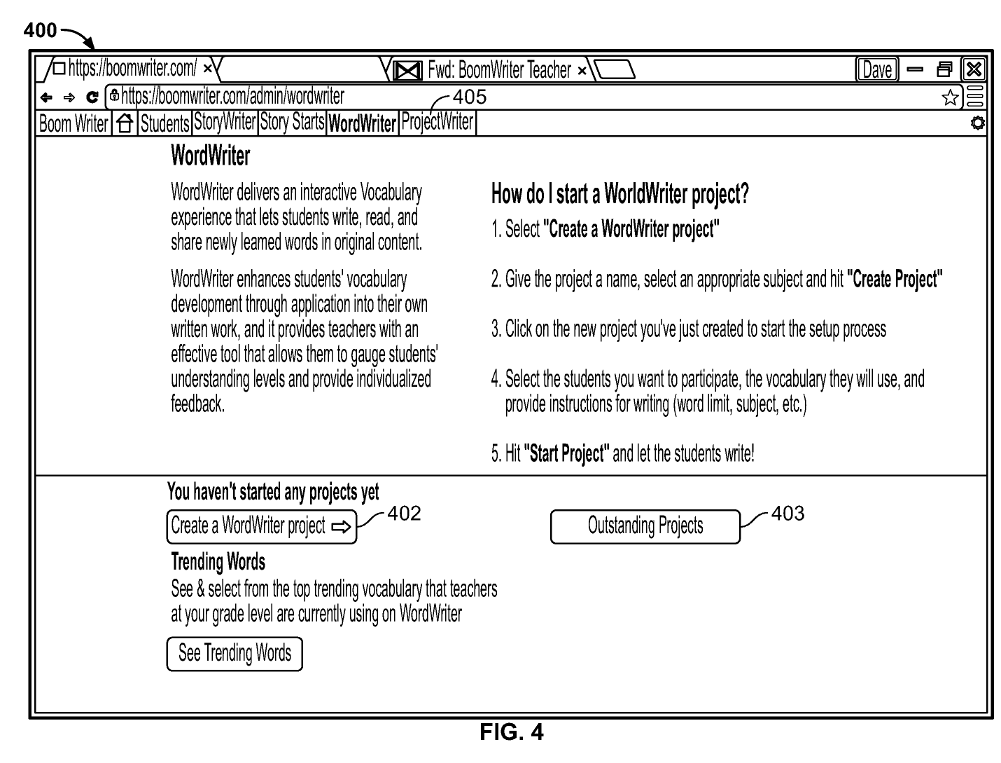

FIG. 4 illustrates an exemplary screenshot of an administrative or teacher portal 400 after login or account creation. Upon access, the teacher can be prompted to create an assignment project through a creation link 402. If pre-existing assignments or projects have been previously created and saved in the system, they can also be accessed here through the outstanding projects link 403 which can access previously saved assignments. Access to other aspects or functions within the system can be accessed through a series of tabs or selections along a user bar 405 provided within the portal 400. Such functions might include student lists, previous assignments, saved assignment drafts, user settings, etc.

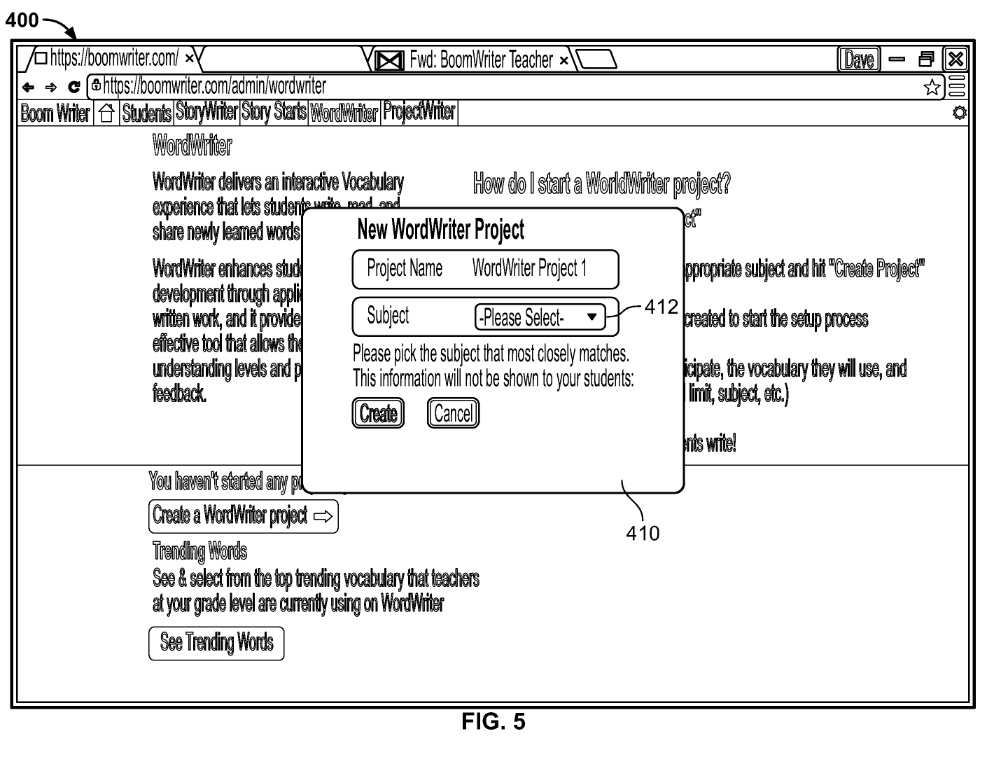

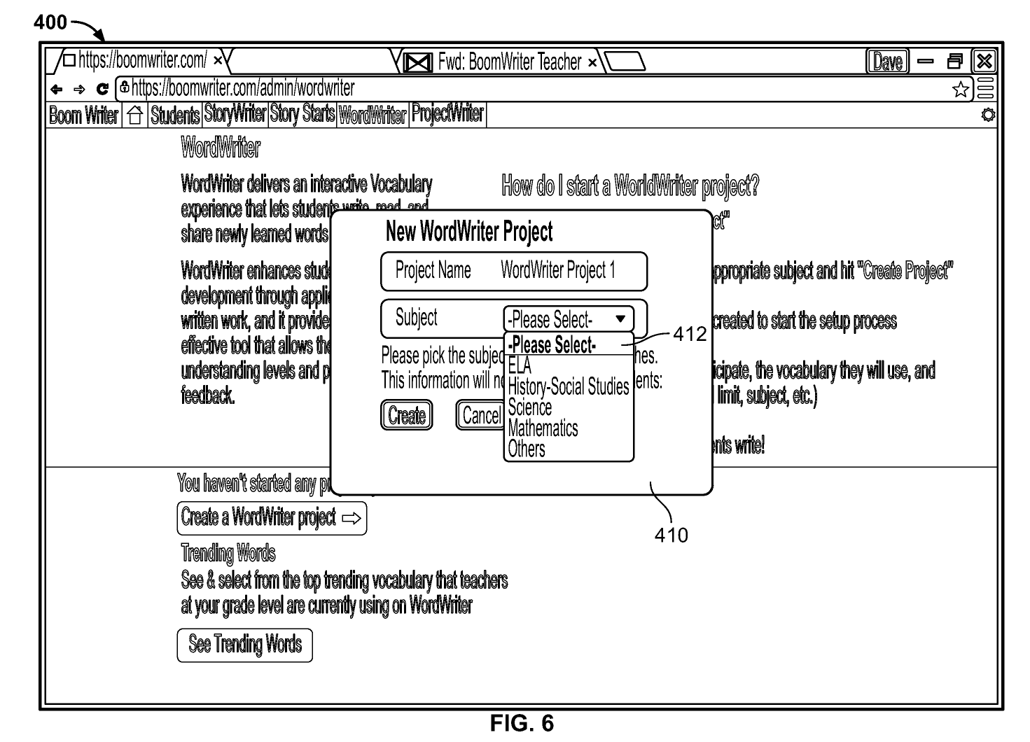

FIG. 5-6 illustrates another exemplary screenshot of the administrative portal 400 after selection of the new assignment project creation link 402. Upon selection new project pane 410 can be presented to the administrative user. The project pane 410 can include various dropdown selection prompts. Shown in FIG. 5 is a subject prompt wherein the options can be pre-populated with various potential subject matters for which a particular administrative teaches. For example, a grade school teacher can include various combinations and sub-combinations of subjects such as Math, Science, Language, History, etc. It will be appreciated that the subject prompts can be pre-programmed or they can retrieve teaching information and potential subjects from the user's created profile information.

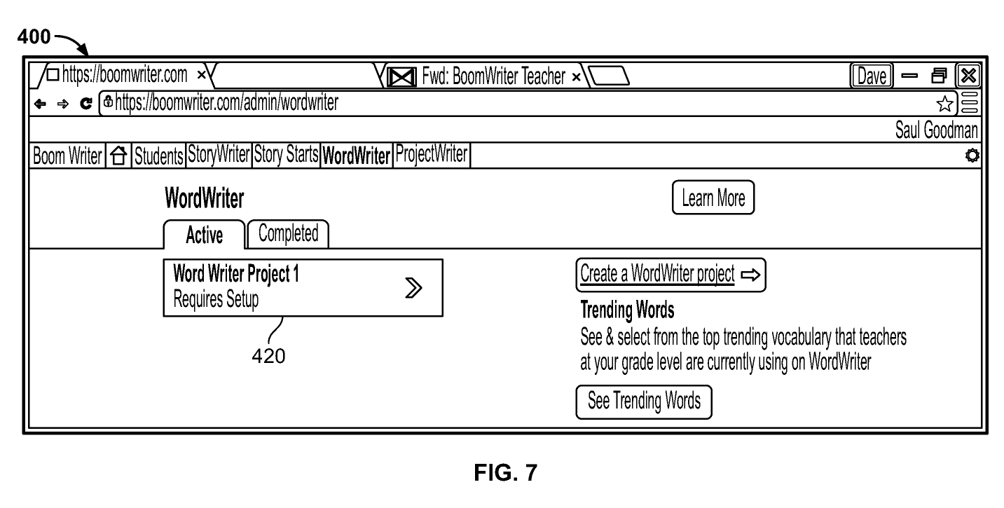

Upon selection of pre-existing options a project profile can be saved in one of the online or local databases. FIG. 7 illustrates another exemplary screenshot of the administrative portal 400 having another pane including a saved project list 420 corresponding to created and saved projects 410. It will be appreciated that some form of indicia can be provided below each project title indicating the status of the completeness of a particular project. Additionally, ready-to-assign projects can be highlighted or otherwise provided with alternative indicia.

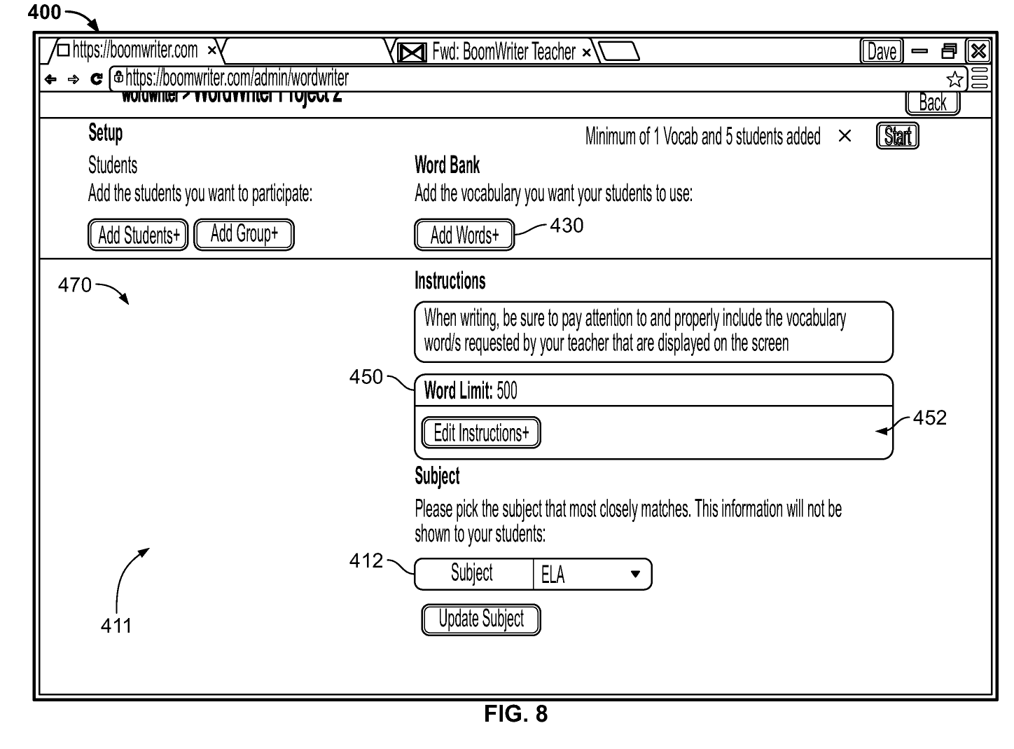

FIG. 8 illustrates another exemplary screenshot of the administrative portal 400 after selection of a particular project being in need of additional setup in a setup pane 411. Inside this setup pane 411, additional options and requirements can be provided for the particular project. Some such options include a student list 470, a vocabulary list or word bank 430, instructions 450, free-form instruction field 452, and a subject description 412. It will be appreciated that additional fields, as will be appreciated by those having skill in the art, can be added or existing fields removed as appropriate for various instruction levels, particular subject fields, or student bases.

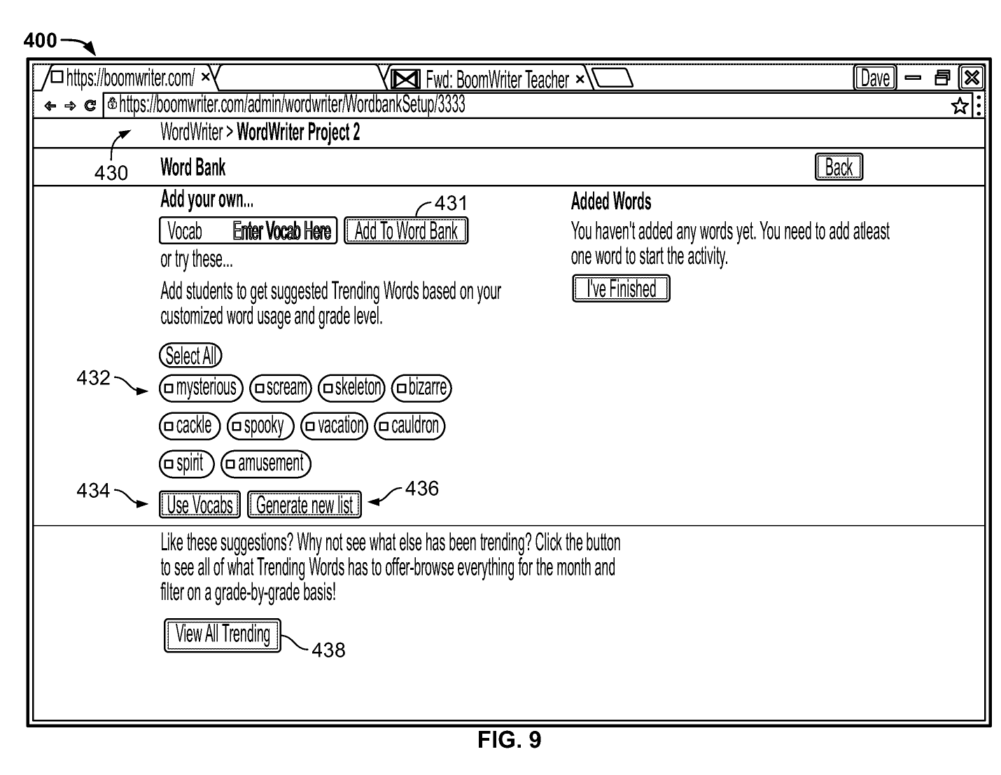

FIG. 9 illustrates another exemplary screenshot of the administrative portal 400 upon selection of a link associated with the vocabulary or word bank 430. Under this input pane the administrator can provide various inputs. For example a free-form vocabulary field 431 can be provided in which the administrator can add particular desired words.

Alternatively, the system can generate a list of potential vocabulary words 432 based on the selected subject. This potential vocabulary word list 432 can be filtered with respect to a selected age group, and subject. Additionally, the system can be configured to retrieve word lists from one or more remotely or locally stored databases, such as approved curriculum for a particular age group, etc. In some embodiments, such as if the administrator likes all of the suggested words, a select all button 434 can be provided in which all of the suggested words can be added to the vocabulary word list associated with the present project. Alternatively, if the administrator disapproves of each of the words or there are insufficient acceptable words, only some of said potential words can be selected, added to the vocabulary word list, and then a new set of words can be generated using the generate new list button 436, wherein selection of which will access a new suggested word list from one or more databases being either locally or remotely located.

As also shown in FIG. 9, in some embodiments, the words used for particular grades and subjects by other system users and associated administrators or teachers, wherein word usage can be tracked and saved in databases stored either locally or remotely. In such instances the usage of particular words can then be tracked in real time and the usage tendency or trends can be used in the system during the generation of particular potential word lists, or can be viewed by the administrators, as such a view trending words link 438 can be provided which allows the administrator to view additional words and their usage by other system users located remotely.

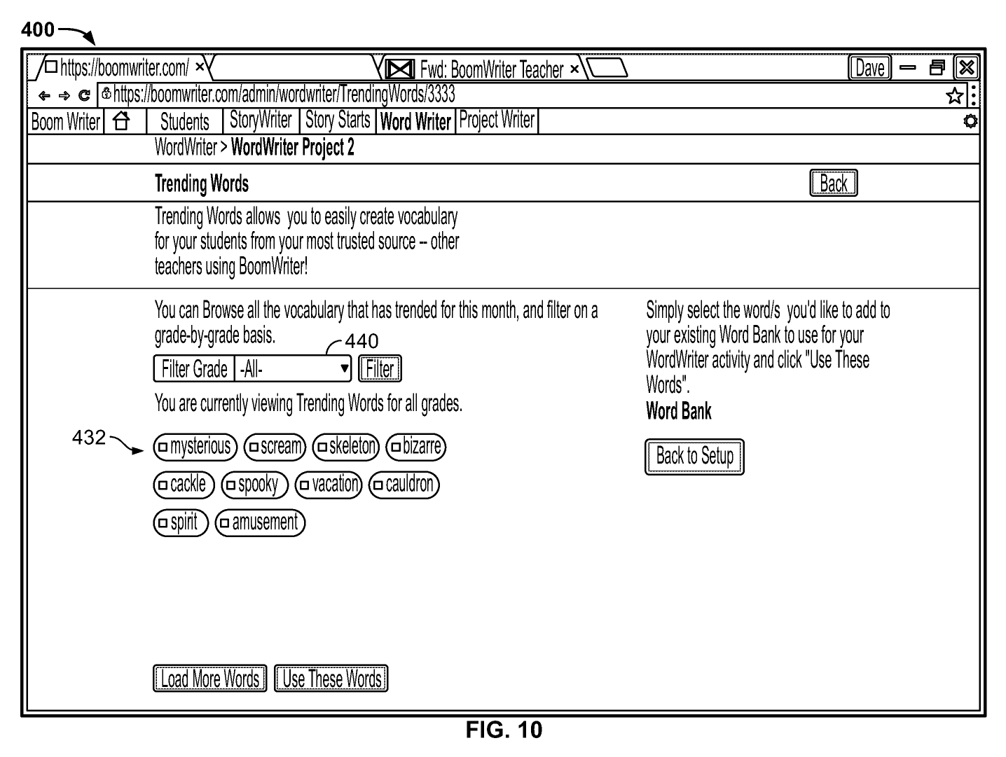

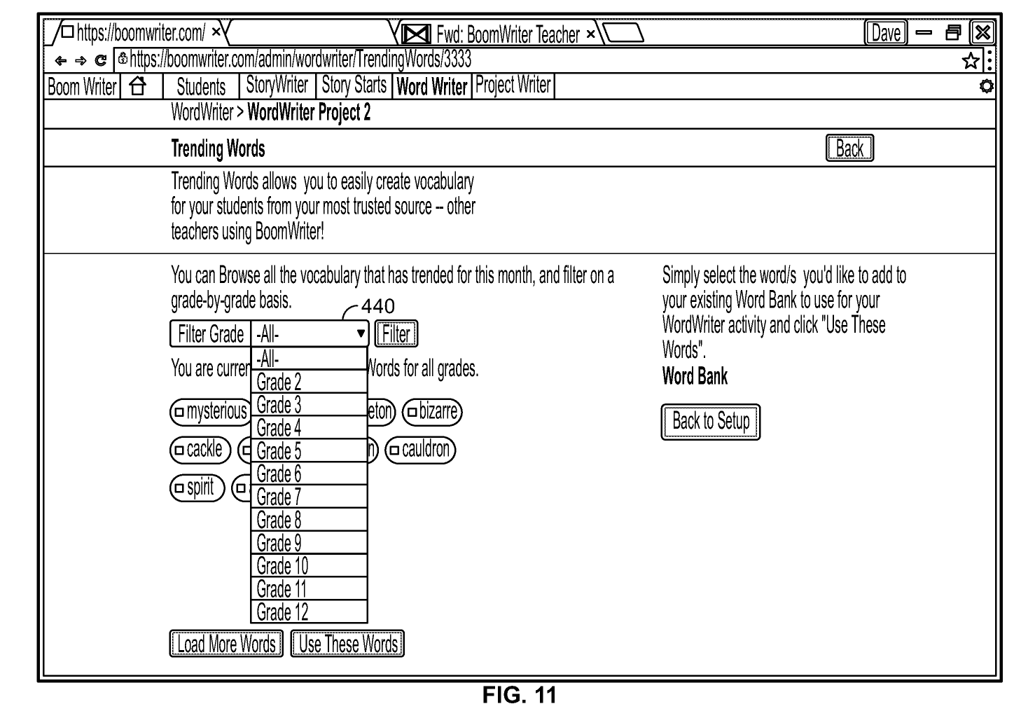

As discussed briefly above, the suggested potential vocabulary words 432 can be filtered based on various criteria including student attributes or subject. One such example is shown in FIGS. 10-11, which illustrates another exemplary screenshot of the administrative portal 400 with a potential vocabulary word list 432, wherein a grade level 440 can be selected, such as 4^{th} grade or 5^{th} grade, wherein the higher level grades will have more difficult or advanced words while the lower grade levels will have more basic words suggested. Alternatively, based on the grade level selection, the system can access approved or suggested curriculums from national or local agencies and their associated suggested vocabularies for a particular grade level. Alternatively, the filter can include a subject matter filter, or any number of filters which could then help the system generate more appropriate potential vocabulary words.

It should be noted that the grade levels shown in FIG. 11 can be modified to include other types of level that may or may not be associated with a particular grade. Levels can be numbered sequentially or given names such ‘rookie’ or ‘master’.

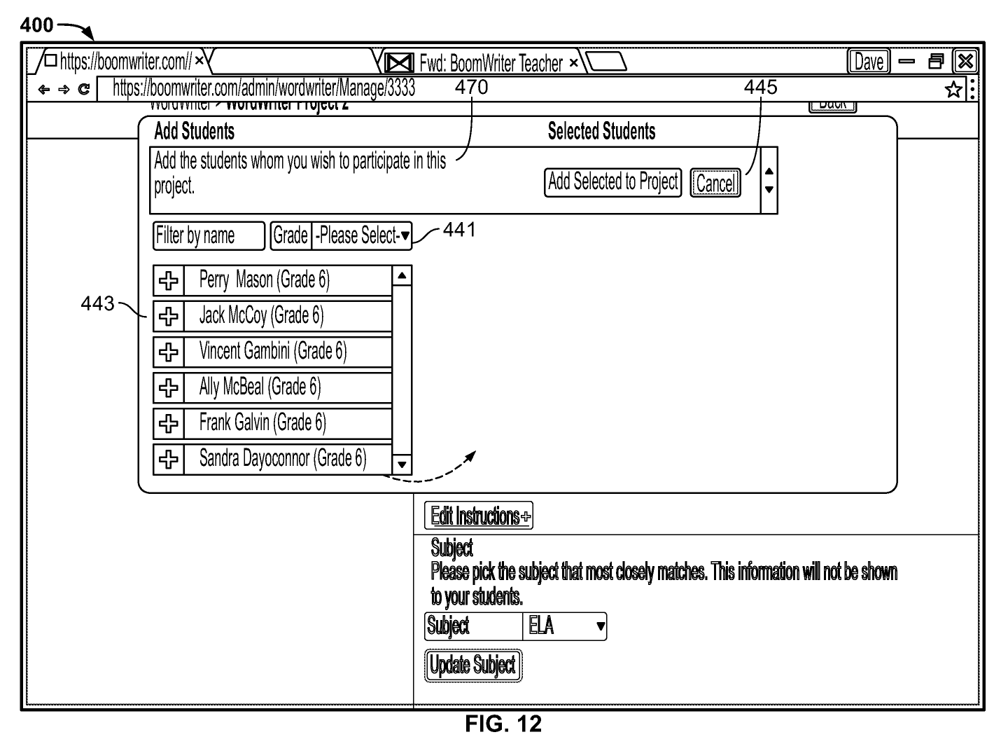

FIG. 12 illustrates another exemplary screenshot of the administrative portal 400 illustrating a student or user selection list 470. It will be appreciated that the individual students or users can be filtered or grouped by grade or other suitable method. In such a manner the student list can be filtered using a grade selection dropdown 441. The users can then be selected so as to associate them with the present project. It will be appreciated that upon selection the students can be moved from the potential student list 443 over to the selected student or user list 441.

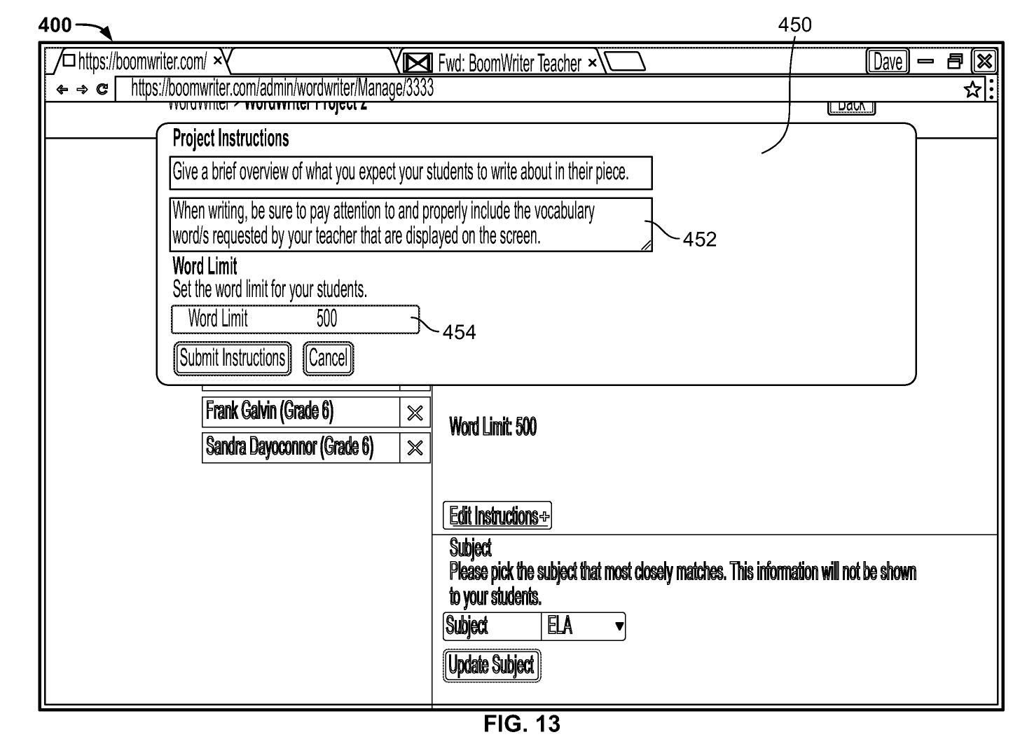

FIG. 13 illustrates another exemplary screenshot of the administrative portal 400 illustrating an instruction pane 450. It will be appreciated that the instruction pane 450 can include various fields and potential requirements to be associated with the project. Some such requirements can include a free-form instruction field 452, a word limit prompt 454, or any other fields as will be appreciated by those having skill in the art. These instructions or requirements can then be associated with or saved into the present projects profile and later shown to students or users upon beginning or accessing the project after it is assigned.

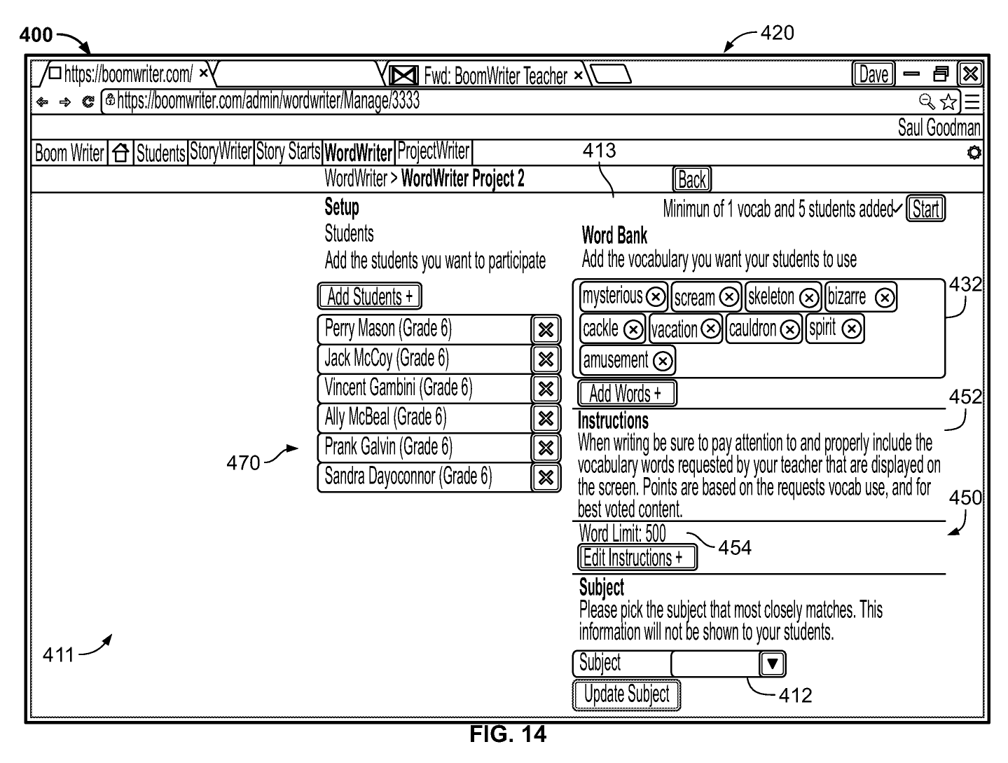

FIG. 14 illustrates another exemplary screenshot of the administrative portal 400 illustrating the setup pane 411 as previously discussed with reference to FIG. 8, however after the project has been set up properly. It will be appreciated that the setup pane now shows the student list 470 associated with the present project, the vocabulary word list or bank 432 associated with the project as well as the word count 450 and other instructions. The administrator/teacher can now be provided with some form of indicia 413 which signals that the assignment is ready to be distributed to the students/users. The indicia can also signal that additional information is incomplete or missing and prompt the administrator to correct defects.

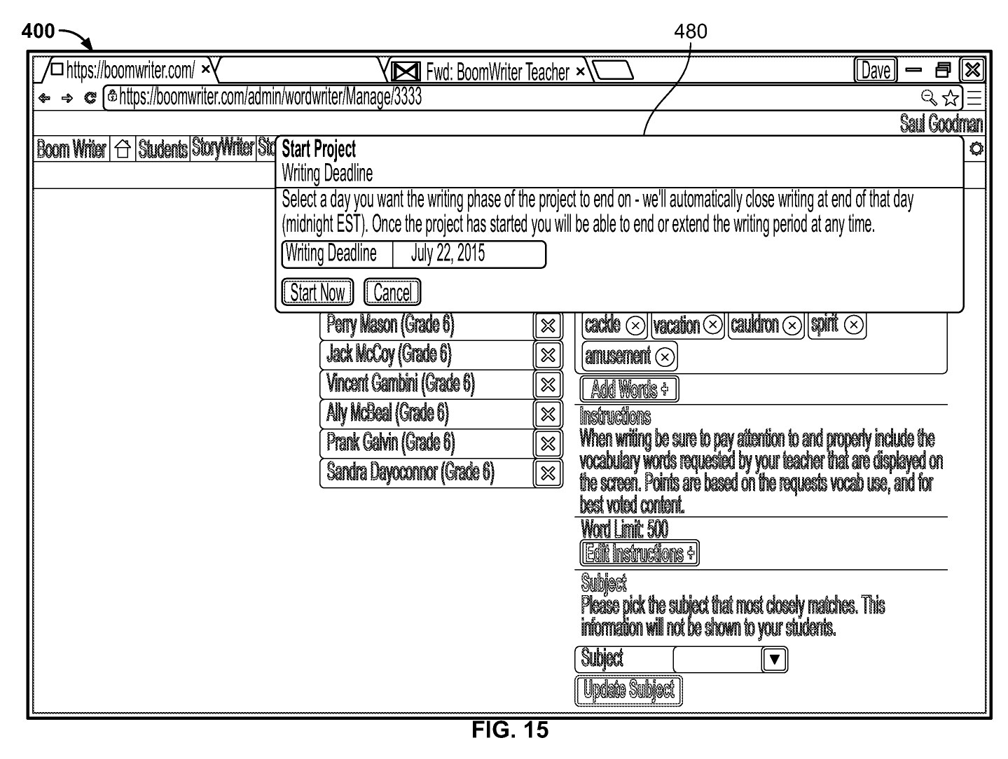

FIG. 15 illustrates another exemplary screenshot of the administrative portal 400 after selection of a start link, as shown in FIG. 14, wherein a final info pane 480 is presented to the administrator. The final info pane can include final due date or deadline information or set the open time period for the assignment, which might just be a countdown or other time limit in class in real time.

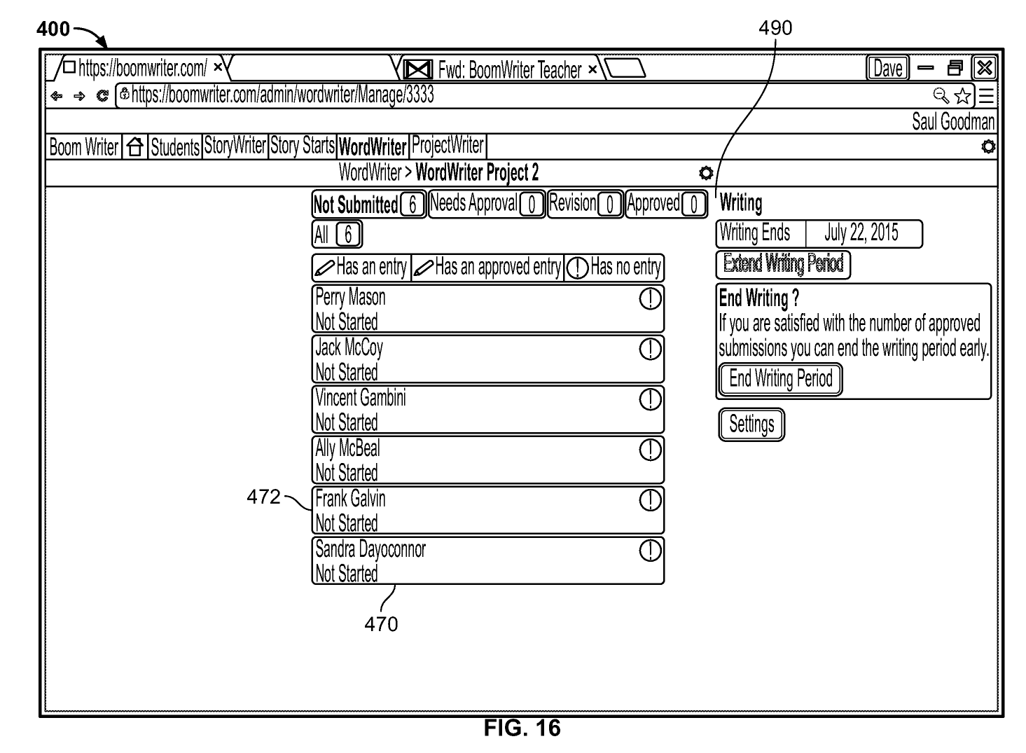

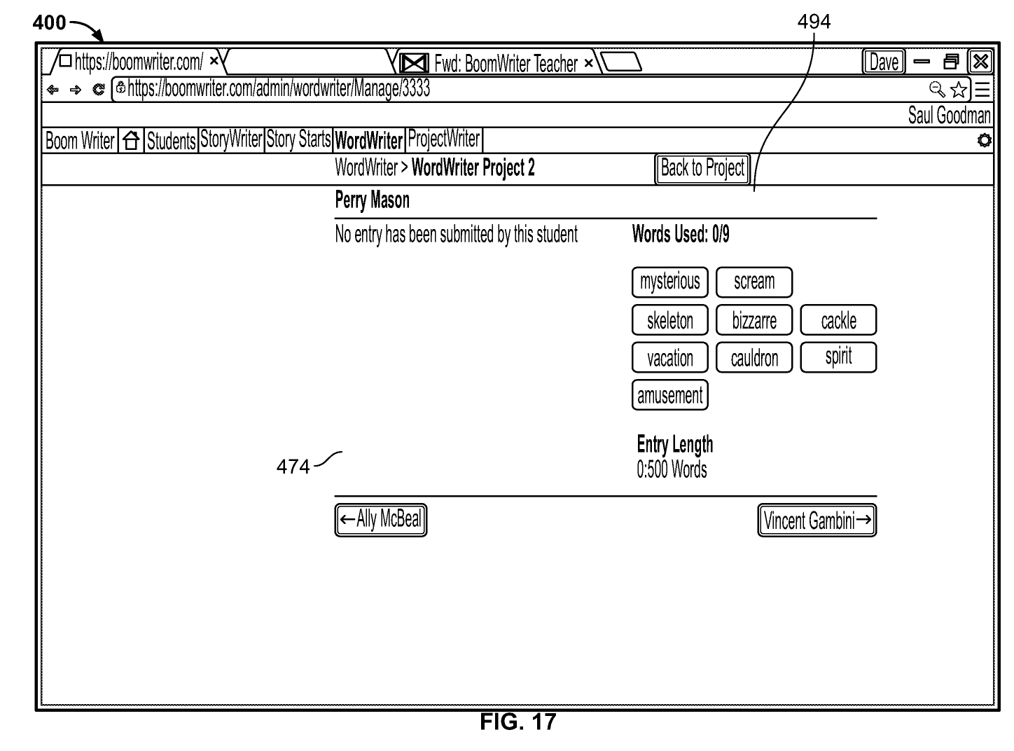

FIG. 16 illustrates another exemplary screenshot of the administrative portal 400 illustrating a status pane 490 after the project has been distributed to the individual students within the student list 470. Each student's progress can be viewed from the status pane 490 with indicia 472 regarding each student's status with regard to the project. As shown in FIG. 17, selection of an individual student can then access in real-time an individual progress pane 494, which reflects what each individual student has input into the their respective user portal in response to the particular project.

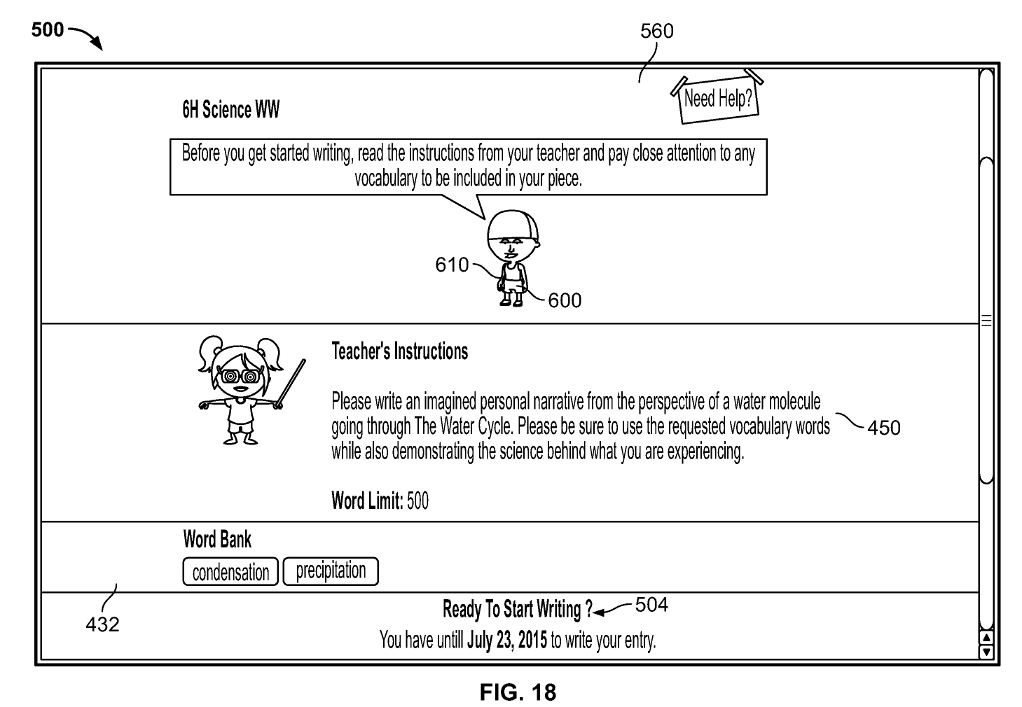

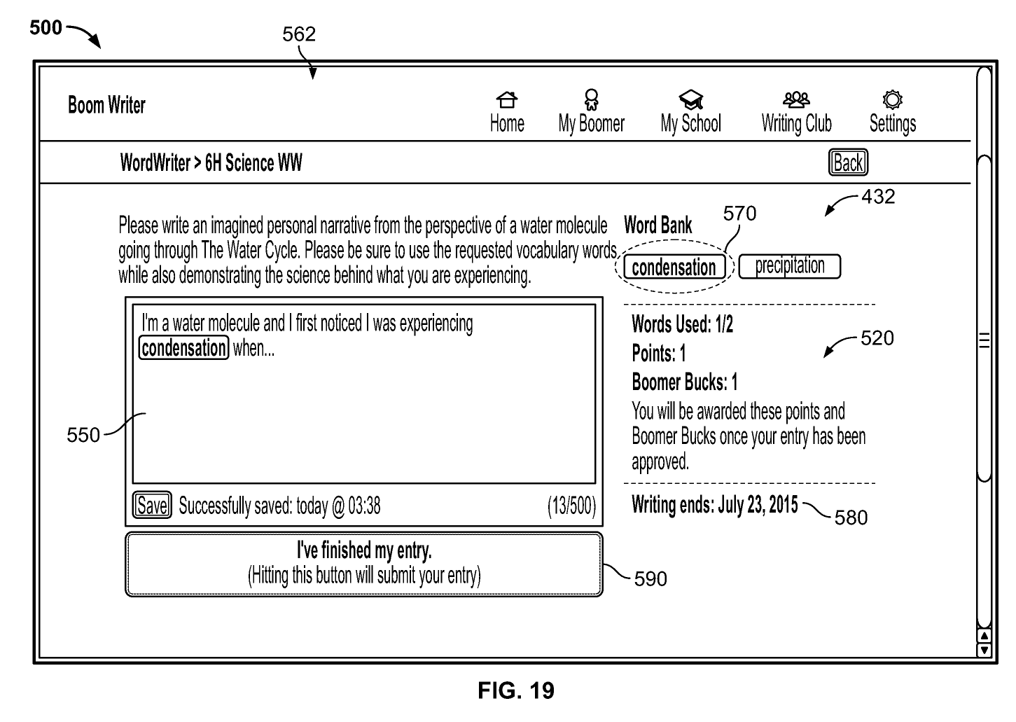

FIG. 18 illustrates an exemplary screenshot of a user portal 500 illustrating a particular project pane 560. It will be appreciated that the individual students or users can see the instructions 450 and the word bank or associated vocabulary list 432. Upon selection of the start button 504 the student can then begin providing input as shown in the project input pane 562 being illustrated in FIG. 19 The users can then input their responses in the user input pane 550, their progress can be tracked in the progress pane 520, and the due date information can be provided in the deadline pane 580.

As a student inputs a response the text of the input response can be tracked and compared to the word bank 432, when a student uses an assigned word appropriately that particular word can be provided with an indicia 570, such as a highlighting, or a checkmark, which indicates that the word has been used, allowing the student to focus on the unused words.

Upon completion the student can press the submission button 590 which indicates that the user has completed their submission and “turns in” the project for grading.

In some embodiments, point values can be associated to the words in the word bank or vocabulary list, wherein points can be awarded for use of particular words and the number of times used in numerous projects and assignments. This score can be saved and recorded. The user can then be provided with an avatar 600, as shown in FIG. 18. The avatar 600 can have a plurality of customizable options 610, wherein certain options can be purchased or unlocked using points awarded from the scoring system and being associated with the word bank and the use of the words therein.

In yet additional embodiments the individual students can be included in a student database where each student is represented as a student entry having information regarding their respective age, grade or education level, etc. being associated with their respective student entry. The system can recognize and save groups of individual students within the student database for easy class or grade level selections. For example, a high school teacher can create an assignment and the group can include the teacher's 5^{th} period geography class. The student database can thus include each student in the school, but the teacher can save a group of those students as a particular class whereupon the class can be chosen and the student list to which the assignment will be issued, as well as the subject, is auto populated. Upon receipt of the required input from the teacher, a list of suggested vocabulary words can be generated. The list of suggested vocabulary words can be processed either locally or remotely by any requisite processing circuitry, i.e. on the teacher's local computer, or on a remote server wherein the requisite data is accessed, processed, and transmitted over a network.

In some embodiments various lists of suggested vocabulary words can be generated using different methods, for example, individual vocabulary words can be retrieved or generated from various sources. For example, if a school district or state has a required curriculum with associated vocabulary, a list can be generated from one of these mandatory curriculums and as such can have a higher priority than alternative words in the generation algorithm.

The score or points shown in FIG. 19 can be used as part of a gamification mode, where rewards, status, prizes are achieved through usage of the vocabulary words in a given content generating activity. As stated elsewhere, content-generating activities can range in all types such as creating a new chapter, story, book, monologue, play, script, poem, technical paper, commercial, movie, instruction pamphlet, crossword puzzle, word find, journal article, thesis, and so forth. In certain gamification modes, some words might be weighted higher than others. In some modes, such as a freestyle mode, the system could be set to gather trending words, so once a plurality of users generate content, the system analyzes the vocabulary words that are trending and assign points or rewards to the users who use the trending words.

In yet other embodiments alternative suggested vocabulary word lists can be generated wherein the words included in the list are pulled from a trending words database. For example, words which alternative educators regularly use in a given subject for a given grade level can be tracked and recognized by the system, and if the word is used by multiple educators the word will be listed higher in the alternative suggested or trending vocabulary word lists discussed above.

This tracking and trending data can be achieved by assigning each word with one or more markers and saved within one of the aforementioned databases. For example, every time a word is used, the word can be marked or otherwise tagged with the age/grade of the students associated with the assignment, the subject, etc. Then the number of uses can be tracked across a plurality of educators and upon creation of an assignment in a specified subject in a specific grade level, the trending words can be suggested so as to supplement any preexisting or mandatory curriculum words.

It will be appreciated that the system can be configured to keep track of previously used words so as to eliminate them from the suggestion lists. In certain embodiments the educators can access and re-use previously assigned words so as to allow educators to track which words were used, in which assignments, or otherwise reassign for refreshing purposes, i.e. for preparation for a standardized test. This option can be configured so as to be selective, so that words can be used multiple times, such as if a teacher determines that the students need to refresh their understanding or use of a particular word or word bank.

The various vocabulary word lists can be presented to the educator in the assignment creation process and the educator can select words from each of the lists as desired so as to create an assignment vocabulary list.

For illustrative purposes, say the teacher wants to create a geography writing assignment, the teacher selects subject type “geography”, and a selection of students. Then the teacher selects a combination of words from combining a mandatory curriculum list and a trending list. The teacher can then provide instructions, for example, “write an essay using each, or as many as possible, of the words from the list describing the terrain and environment of any location of your choosing”. The instructions are saved, and a new assignment is created which includes the words as well as the instructions.

At this point the new assignment can then be transmitted to each of the students, each word in the assignment has a series of markers associated with it, as discussed above, so as to provide markers for updating the trending word database or update the database from which trending words are pulled for other educators or teachers.

The students can then each be provided with a notification in a student portal. Or alternatively each of the students can be provided with instructions on how to access the assignment via some other notification format, i.e. email or sms. The students can then access the assignment using a student portal and an associated student profile, for example using a login on a personal electronic device, the portal will provide instructions and request input from the student so as to complete the assignment, for example a text input box.

The students can then be allowed to type their response into the input box. In some embodiments the assignment vocabulary list can be displayed next to the input area such that the students can easily see which words they need to use as they input their response. As discussed above, in some embodiments the text of their response can be processed in real-time and compared to the words of the word bank. This processing can cause an indicator associated with each word to change status as the words are used. Such an indicator can include changing the color of the text from red to green as the words are used, alternatively a check box next to each word can be checked as the words are used. It will be appreciated that any readily ascertainable indicia can be used so as to notify the students of the words used as each are recognized within the text.

In some embodiments the educator's portal can have the ability to track and monitor each student's entry in real time as the input is received. In such embodiments the input from each student can be continuously saved and transmitted across a local area network wherein only the teacher can access each student's work as it is input.

When the assignment is completed, the students can save their work, and in some instances the educator or teacher will then be allowed to display or share the entries with all of, or selected members of, the rest of the class.

In yet other embodiments the teacher can be allowed to offer comments or suggestions to the student to help them complete the assignment, for example in the case of writer's block the teacher could suggest a next move for a character, etc.

It will be appreciated that often there can be a time limit or a due date associated with a given assignment. In such cases, each user's input can be automatically saved and additional input cut off upon the passing of the specified timeframe or due date.

In some embodiments the students can be given incentives for using more of the words from the assignment list. Such incentives can include arbitrary points or virtual money which can be used to unlock features or accessories for an avatar associated with each user within their online portal or login wherein using a higher percentage gives a higher reward and fewer gives a lesser reward, etc.

In yet additional embodiments a method of forming a vocabulary database is contemplated. This method can include extracting from one or more writing assignments, words used, subject type of the writing assignment, and the grade level associated with each student generating the words used in generating the completed written assignment. It will be appreciated that increasing the number of assignments from an increasing number of teachers or users can increase the veracity and provide a richer pool of vocabulary from which future assignments can be generated. In some embodiments the assignments from which vocabulary is determined and recognized can be filtered to specific parameters. For example filtering the recognition and analysis to writing assignments within a specific region, school district, city, county, state or country can help users in zones with specific curriculum in generating an appropriate vocabulary database.

In some embodiments tallying counts associated with each vocabulary word associated with each subject and each grade level can be useful in generating databases appropriate for specific grade levels, subjects etc. wherein the database can be prioritized based on usage such that more relevant or more used words are listed first, wherein it will be appreciated that usage can often reflect importance of such a word in a given curriculum, region, subject, etc.

In some embodiments the database can access and select words any of the lists mentioned above and compare the list with a known standard of vocabulary words so as to determine which words are redundant, separate them to indicate which are mandatory, and which only suggested, etc.

In yet other embodiments a method of generating a vocabulary database is contemplated. This method can include receiving an assignment vocabulary list, the assignment vocabulary list can include a plurality of individual vocabulary words. Each of the assignment vocabulary lists can be processed and each of the words therein can be recognized. Additional information regarding a class list associated with the assignment vocabulary list can be received, wherein the information includes associated grade levels of a plurality of students associated with the class list as well as a subject associated with the assignment vocabulary list. The information can then be used to generate and attach one or more markers to each individual vocabulary word, each marker containing information regarding at least the subject information associated with the assignment vocabulary list and the grade levels of each of the plurality of students. Additional markers can include usage information regarding relationships between particular words and alternative words, for example, two words might often be included in the same list, which relationship can bump the related word up in the suggestion list.

Each of the words and the associated markers can then be imported or transmitted to a word database stored on a remotely accessible non-transitory computer-readable medium. In some instances the word database can be copied and accessed on local computers having local non-transitory computer-readable mediums.

The method can further include a step of accessing the word database from a user portal, receiving information pertaining to a desired grade level, and receiving information pertaining to a desired subject each of which pertain to a desired new assignment. Then processing circuitry located either on a local computer or on a remote server can determine a suggested vocabulary list.

Having described certain embodiments of the various methods and systems it will now become apparent to one of skill in the art that other embodiments incorporating the concepts of the disclosure may be used in various combinations as appropriate, and that any particular embodiment can include other features or variations as disclosed in any other embodiment. Additionally, as standard terminologies or methodologies change, that such variations can also be adapted to include features or method steps as discussed herein. Therefore, the disclosure should not be limited to certain embodiments, but rather should be limited only by the spirit and scope of the following claims.

What is claimed is:

1. A method for generating a new vocabulary based writing assignment, performed by at least one computer processor executing computer program instructions stored on at least one non-transitory computer-readable medium, the method comprising:
receiving, by a server, from an administrator portal, a request to generate a new writing project from an administrator;
receiving input from the user regarding a desired subject being associated with the new writing project;
receiving input from the administrator regarding one or more users to be associated with the new writing project, wherein the one or more users are selected from a user database being stored on a non-transitory computer-readable medium;
generating a potential vocabulary word list, the potential vocabulary word list including a plurality of suggested vocabulary words, the potential vocabulary word list being generated using the processing circuitry, the suggested vocabulary words being retrieved from a vocabulary database being stored on the non-transitory computer-readable medium, wherein each of the individual vocabulary words in the list of suggested vocabulary words are correlated to one or more attributes of the one or more users and the desired subject;
selecting one or more individual vocabulary words from the potential vocabulary word list;
forming a word bank being associated with the new writing project using the selected individual vocabulary words;
receiving assignment instructions from the administrator, the assignment instructions correlating to the new writing project; and
generating a complete writing project using processing circuitry wherein the word bank, and the assignment instructions are transmitted over a network to each of the one or more users selected from the user database.

2. The method of claim 1, further comprising:
generating a secondary list of potential vocabulary words, the secondary list of suggested vocabulary terms being based on an associated grade level of the one or more users, the desired subject, and usage information from additional user's having a similar assignment attributes.

3. The method of claim 1, wherein the vocabulary database includes a plurality of vocabulary words, each of the vocabulary words including associated usage markers for each individual vocabulary word.

4. The method of claim 3, wherein each of the usage markers include information regarding the grade level of each of the one or more users, the number of times the particular vocabulary word has been assigned, and the associated desired subject of the new assignment.

5. The method of claim 4, further comprising:
generating a secondary list of potential vocabulary words, the secondary list of potential vocabulary words being based on the usage markers.

6. The method of claim 1, wherein the potential vocabulary word list includes a plurality of vocabulary words generated from a preexisting standard curriculum database.

7. The method of claim 5, wherein the potential vocabulary word list includes a plurality of vocabulary words from a preexisting standard curriculum database.

8. The method of claim 5, wherein each of the vocabulary words within the secondary list of potential vocabulary words is ranked according to frequency of use.

9. The method of claim 3, wherein the usage markers include information regarding relationships between words which are frequently selected together.

10. The method of claim 1, further comprising:
transmitting the complete writing project to the one or more users;
receiving a user input relating to the new assignment from each of the one or more users;
analyzing the input from each of the one or more users during the input using processing circuitry; and
determining a match between portions of the user input and each of the individual vocabulary words from the associated word bank and associated complete writing project.

11. The method of claim 10, further comprising:
displaying the word bank while receiving the user input; and
providing a status indicator regarding each individual vocabulary word from the word bank as each individual vocabulary word is used.

12. The method of claim 10, further comprising:
receiving a status input from the user upon completion of the new assignment.

13. The method of claim 10, further comprising:
progressively transmitting the user input to the administrator; and
providing a means for the administrator to continuously monitor the user input of each user.

14. A method of creating a database of subject and grade level appropriate vocabulary words comprising the steps of:
extracting usage information regarding individual vocabulary words used in a word bank for a plurality of complete writing assignments, the usage information further comprising:
individual word usage;
subject type associated with the complete writing assignment; and a grade level associated with each of a plurality of users to which the complete writing assignment has been assigned; and
generating the words used in generating the completed written assignment.

15. The method of claim 14, further comprising the step of extracting from a plurality of writing assignments one or more informational markers, including at least some regional defining information selected from a group consisting of school name, district name, city, county, state and country.

16. The method of claim 14, further comprising the steps of:
creating a word database on one or more non-transitory computer-readable media;
associating a plurality of informational markers with each individual vocabulary word within the word bank, the informational markers including information with regard to associated subject and grade level; and
storing informational markers, the word database including the informational markers associate with each of the individual vocabulary words

17. The method of claim 16, further comprising the steps of:
selecting from the word database a plurality of potential vocabulary word selections based on frequency of use; and
comparing said list with a secondary list of known standard vocabulary words.

18. A method of generating a vocabulary database, the method comprising:
receiving a word bank associated with a complete writing project, the word bank including a plurality of individual vocabulary words;
receiving information regarding a user list including information regarding grade levels of a plurality of users associated with a particular class list;
receiving subject information associated with the word bank and completed project;
associating one or more markers to each individual vocabulary word, the one or more markers including information regarding at least the subject information associated with the word bank and the grade levels of each of the plurality of users;
importing the word bank list into a word database stored on a remotely accessible non-transitory computer-readable medium;
accessing the word database from an administrative portal;
receiving information pertaining to a desired grade level;
receiving information pertaining to a desired subject; and
determining a potential vocabulary word list, the potential vocabulary word list being determined by process circuitry wherein each individual vocabulary word is ranked based on a word use frequency for each individual vocabulary word within the word database, the use frequency being further filterable with respect to at least the grade level, and subject information.

19. The method of claim 18, further comprising:
extracting usage information regarding individual vocabulary words used in the word bank for a plurality of complete writing assignments, the usage information further comprising:
individual word usage;
subject type associated with the complete writing assignment; and a grade level associated with each of a plurality of users to which the complete writing assignment has been assigned; and
generating the words used in generating the completed written assignment.

20. The method of claim 18, further comprising the step of extracting from a plurality of complete writing assignments one or more informational markers, including at least some regional defining information selected from a group consisting of school name, district name, city, county, state and country.
